(19) United States
(12) Patent Application Publication
(10) Pub. No.: US 2013/0293433 A1
(43) Pub. Date: Nov. 7, 2013

(54) ANTENNA DEVICE

(71) Applicant: FUJITSU LIMITED, Kawasaki-shi (JP)

(72) Inventors: Shohei Ishikawa, Yokohama (JP); Teruhisa Ninomiya, Yokohama (JP)

(73) Assignee: FUJITSU LIMITED, Kawasaki-shi (JP)

(21) Appl. No.: 13/731,569

(22) Filed: Dec. 31, 2012

(30) Foreign Application Priority Data
May 1, 2012 (JP) 2012-104617

(51) Int. Cl. H01Q 13/10

(52) U.S. Cl. CPC H01Q 13/106
USPC 343/767

(57) ABSTRACT

An antenna device includes: a substrate; a slot including an earth electrode, a first side, a second side, a first bent part and a second bent part, the first side and the second side being orthogonal and one end of the first side coupled to one end of the second side, the first bent part coupled to the other end of the second side and provided in parallel to the first side, the first bent part being shorter than the first side, the second bent part coupled to the other end of the first side and provided in parallel to the second side, the second bent part being shorter than the second side; a first feeding point provided on the earth electrode; a second feeding point provided on the earth electrode; a first switch provided on the first side; and a second switch provided on the second side.

### CROSS-REFERENCE TO RELATED APPLICATIONS

This application is based upon and claims the benefit of priority from the prior Japanese Patent Application No. 2012-104617 filed on May 1, 2012, the entire contents of which are incorporated herein by reference.

### FIELD

The embodiments discussed herein are related to an antenna device.

### BACKGROUND

A slot antenna is formed by providing a slot in an earth electrode, so that the slot antenna is provided in a circuit substrate or a part mounting area. Use of the slot antenna minimizes the size of a radio communication apparatus.

The related art is disclosed in Japanese Laid-open Patent Publication No. 2002-9540, Japanese National Publication of International Patent Application No. 2005-525036, Japanese National Publication of International Patent Application No, 2005-514844, or Japanese Laid-open Patent Publication No. 2006-157129.

### SUMMARY

According to one aspect of the embodiments, an antenna device includes; a substrate; a slot, provided on the substrate, including an earth electrode, a first side, a second side, a first bent part and a second bent part, the first side and the second side being mutually orthogonal and one end of the first side coupled to one end of the second side, the first bent part being coupled to the other end of the second side and provided in parallel to the first side, the first bent part being shorter than the first side, the second bent part coupled to the other end of the first side and provided in parallel to the second side, the second bent part being shorter than the second side; a first feeding point provided on the earth electrode in a vicinity of the first bent part; a second feeding point provided on the earth electrode in the vicinity of the second bent part; a first switch provided on the first side; and a second switch provided on the second side.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 illustrates an exemplary plain view of an antenna device;

FIG. 2 illustrates an exemplary cross-section view of an antenna device;

FIG. 3A and FIG. 3B illustrate an exemplary plain view of an antenna device;

FIG. 4A and FIG. 4B illustrate an exemplary simulation result of current distribution;

FIG. 5A and FIG. 5B illustrate an exemplary simulation result of a gain of a horizontally-polarized wave and a vertically-polarized wave and a directionality pattern;

FIG. 6 illustrates an exemplary simulation result indicating a relationship between a length of a bent part and a correlation coefficient between polarized waves;

FIG. 7 illustrates an exemplary plain view of an antenna device; and

FIG. 8 illustrates an exemplary plain view of an antenna device.

### DETAILED DESCRIPTION OF THE EMBODIMENTS

To receive a plurality of radio waves having various polarization planes, an antenna for each of the polarization planes is provided. According to polarized wave diversity, a radio wave with a high strength from among the radio waves is preferentially used. A slot antenna that produces the effect of the polarized wave diversity is provided.

For example, two emitting units a cross-shaped slot formed on a conductor plate, which are mutually orthogonal, are fed.

In an antenna device, an earth conductor that includes two slots having a small electrical separation and a unit for coupling a transceiver to each of the slots functions as two antennas.

An antenna includes a feeding point, which is provided at an L-shaped corner of the slot formed in an L-shaped form on a conductive ground surface, and two MEMS switches provided close to both sides of the feeding point. Regarding the antenna, an arm having a closed MEMS switch is short-circuited, and the other arm emits or receives an RF signal.

The antenna device includes a square-shaped emission conductor that is formed on the front surface of a dielectric substrate, an earth conductor that is formed on the back surface of the dielectric substrate, and a conductor pin that is coupled to the center of the emission conductor and is used to feed the emission conductor from the earth conductor side. The antenna device includes a square loop-shaped slot line that is provided on the emission conductor to surround a coupling position of the emission conductor and the conductor pin and includes a plurality of switching units that is provided in a prescribed interval on the slot line and that switches the existence of interruption of the slot line.

When the slot antenna that emits a radio wave having a prescribed polarization plane is fed, a current may flow into the other slot antenna that emits the radio wave having the polarization plane that is orthogonal to the prescribed polarization plane. Therefore, the antenna device may emit or receive the radio wave having the two polarization planes that are mutually orthogonal.

For example, the antenna device has a slot having a shape obtained by bending both ends of the L-shaped form at a right angle and formed in the earth electrode on a dielectric substrate. On the side of the slot facing each of the ends of two bent parts, switches are provided to conduct or electrically interrupt earth electrodes that sandwich the slot. When one of the switches is turned on, the antenna device functions as one of the U-shaped slot antennas that are mutually orthogonal. For example, the switch included in one of the slot antennas may be allocated in a position where the relatively small current flows when the other slot antenna is fed. Since the current flowing in the slot antenna that is not fed becomes small, coupling of the slot antennas may be reduced.

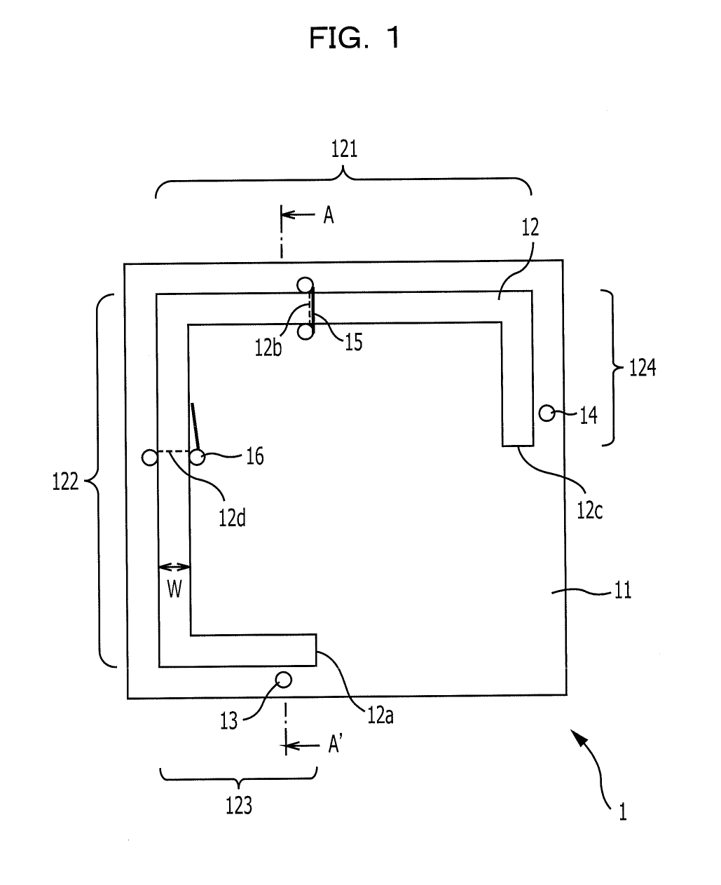

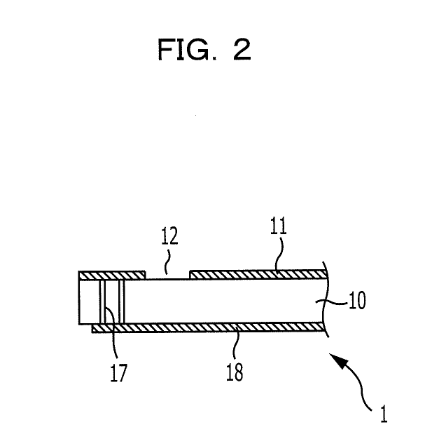

FIG. 1 illustrates an exemplary plain view of an antenna device. FIG. 2 illustrates an exemplary a cross-section view of an antenna device. Regarding an AA′ line illustrated in FIG. 1 viewed from the directions of the arrows, FIG. 2 is a cross-section diagram of a side surface in the vicinity of a feeding point. An antenna device 1 includes a substrate 10 and an earth electrode 11 provided on the substrate 10. The substrate 10 may include a dielectric body such as glass and epoxy resin. The earth electrode 11 may include a conductive material such as copper and gold. For convenience sake, the direction in parallel to the left end or the right end of the earth electrode 11 illustrated in FIG. 1 may be referred to as a vertical direction. The direction in parallel to the upper end or the lower end of the earth electrode 11 may be referred to as a horizontal direction.

In the earth electrode 11, a slot 12 having a form obtained by bending both ends of the L-shaped form at a right angle is formed. For example, the slot 12 includes a first side 121 extending along the horizontal direction and being formed near the upper end of the earth electrode 11 and a second side 122 extending along the vertical direction and being formed near the left end of the earth electrode 11.

The length of the first side 121 and the second side 122 may be shorter than a half of the resonant wavelength of the radio wave that is emitted or received. The length of the first side 121 and the length of the second side 122 may be substantially the same or different from each other. The first side 121 and the second side 122 are mutually orthogonal and coupled to each other at one end. The other end of the second side 122, for example, the end of the lower side illustrated in FIG. 1 is coupled to a bent part 123 that is parallel to the first side 121 and shorter than the first side 121. The other end of the first side 121, for example, the end of the right side illustrated in FIG. 1 is coupled to a bent part 124 that is parallel to the second side 122 and shorter than the second side 122. The sides of the slot 12 and the bent parts may be formed to be substantially parallel to the nearest end sides in the earth electrode 11, respectively. A width W of the slot 12 may be substantially the same in the sides and the bent parts. Regarding the center line of the vertical direction or the center line of the horizontal direction of the earth electrode 11, the slot 12 may be formed to have a shape that is line-symmetric with respect to the shape illustrated in FIG. 1.

In the vicinity of an end point 12a of the bent part 123 on the lower side of the slot 12 and of an end point 12c of the bent part 124 on the right side of the slot 12, a feeding point 13 and a feeding point 14 are formed in the earth electrode 11 that is adjacent to the outside of the slot 12, respectively. As illustrated in FIG. 2, in the feeding point 13, a via 17 that passes through to the back surface of the substrate 10 from the front surface of the substrate 10 on which the earth electrode 11 is provided. The earth electrode 11 is electrically coupled, through the via 17, to a conductive wire 18 provided on the back surface of the substrate 10. A microstrip line is formed by the conductive wire 18 and the earth electrode 11. A circuit (not illustrated) for radio signal processing provided on the back surface of the substrate 10 is coupled to the feeding point 13 through the conductive wire 18. The structure of the feeding point 14 is substantially the same as or similar to the structure of the feeding point 13.

The distance between the end point 12a of the slot 12 and the feeding point 13 may be determined so that impedance of the slot antenna of the feeding point 13 is consistent with the impedance of the micro strip line formed by the conductive wire 18 and the earth electrode 11. The distance between the end point 12c of the slot 12 and the feeding point 14 may be determined so that the impedance of the slot antenna of the feeding point 14 is consistent with the impedance of the micro strip line formed by the conductive wire for the feeding to the feeding point 14 and the earth electrode 11. The closer to the end point 12a or the end point 12c the feeding point 13 or the feeding point 14 is provided, the higher the impedance of the slot antenna may be.

On the first side 121 on the upper side of the slot 12, a switch 15 is provided. The switch 15 may be allocated in such a way that the distance between a position 12b in which the switch 15 is provided and an intermediate point of the second side 122 on the left side is longer than the distance along the slot 12 between the intermediate point and the feeding point 13 and is shorter than the distance between the intermediate point and the end point 12a. The switch 15 in the position 12b may conduct a part of the earth electrode 11 that is adjacent to the inside of the slot 12 and a part of the earth electrode 11 that is adjacent to the outside of the slot 12, and the switch 15 may electrically interrupt the conduction therebetween. A switch 16 is provided on the second side 122 on the left side of the slot 12. The switch 16 may be provided in such a way that the distance along the slot 12 between the position 12d in which the switch 16 is provided and the intermediate point of the first side 121 on the upper side is equal to or longer than the distance along the slot 12 between the intermediate point and the feeding point 14 and is equal to or shorter than the distance between the intermediate point and the end point 12c. The switch 16 in the position 12d may conduct a part of the earth electrode 11 that is adjacent to the inside of the slot 12 and a part of the earth electrode 11 that is adjacent to the outside of the slot 12, and the switch 16 may electrically interrupt the conduction therebetween.

The switch 15 and the switch 16 may have, for example, a Single Pole Single Throw (SPST) structure. For example, the switch 15 and the switch 16 may be formed as a Micro Electro Mechanical Systems (MEMS). The switch 15 and the switch 16 may be coupled to a control circuit (not illustrated) and controlled based on a control signal from the control circuit. For example, when the switch 15 and the switch 16 are turned on, the outside part and the inside part of the earth electrode 11 facing each other across the slot 12 are conducted. When the switch 15 and the switch 16 are turned off, the conduction of the outside part and the inside part of the earth electrode 11 is electrically interrupted.

Regarding the antenna device 1, when a radio wave is emitted or received, one of the switch 15 and the switch 16 may be turned on according to the control signal from the control circuit (not illustrated).

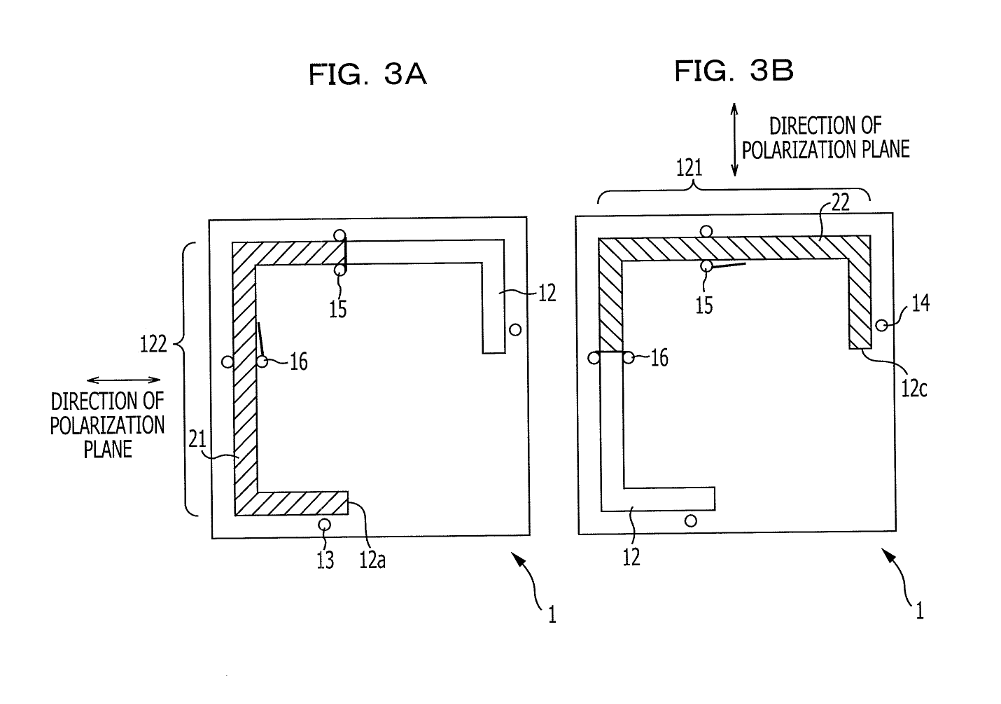

FIG. 3A and FIG. 3B illustrate an exemplary plain view of an antenna device. FIG. 3A may illustrate a plain view of the antenna device 1 when the switch 15 is turned on and the switch 16 is turned off. For example, a U-shaped section 21 between the end point 12a on the lower side of the slot 12 and the switch 15 may function as a slot antenna. The slot antenna may resonate with the radio wave of which the wavelength is twice as long as the U-shaped section 21. Therefore, the signal that is fed from the feeding point 13 is emitted from the U-shaped section 21 as a radio wave of which the wavelength is twice as long as the section 21. For example, the radio wave of which the wavelength is twice as long as the section 21 is transmitted into the circuit or the path (not illustrated) for the radio signal processing through the feeding point 13. In an approximately center part in the section 21, for example, the second side 122, the electric field may become strongest along the direction for coupling the outside to the inside of the slot 12. Due to the provided position of the switch 15, in the section 21, the length from the upper end of the second side 122 to the switch 15 may be substantially the same as the length from the lower end of the second side 122 to the end point 12a of the slot 12. Therefore, the linearly-polarized wave having the polarization plane along the width direction of the second side 122 is emitted or received.

FIG. 3B may illustrate a plain view of the antenna device when the switch 15 is turned off and the switch 16 is turned on. For example, the U-shaped section 22 between the end point 12c on the right side of the slot 12 and the switch 16 may function as a slot antenna. The slot antenna may resonate with the radio wave of which the wavelength is twice as long as the U-shaped section 22. Therefore, the signal fed from the feeding point 14 is emitted from the U-shaped section as the radio wave of which the wavelength is twice as long as the section 22. For example, the radio wave, of which the wavelength is twice as long as the section 22, received in the U-shaped section 22 is transmitted to the circuit or the path (not illustrated) for the radio signal processing through the feeding point 14. In the approximately center part in the section 22, for example, in the first side 121, the electric field may become strongest along the direction for coupling the outside and the inside of the slot 12. Due to the provided position of the switch 16, in the section 22, the length from the left end of the first side 121 to the switch 16 may be substantially the same as the length from the right end of the first side 121 to the end point 12c of the slot 12. Therefore, the linearly-polarized wave having the polarization plane along the width direction of the first side 121 is emitted or received. For convenience sake, the linearly-polarized wave having the polarization plane along the width direction of the first side 121, for example, the vertical direction may be referred to as a vertically-polarized wave. The linearly-polarized wave having the polarization plane along the width direction of the second side 122, for example, the horizontal direction may be referred to as a horizontally-polarized wave.

In the antenna device 1, since the switches 15 and 16 are turned on or off, the radio wave having one of the two polarization planes that are mutually orthogonal is emitted or received.

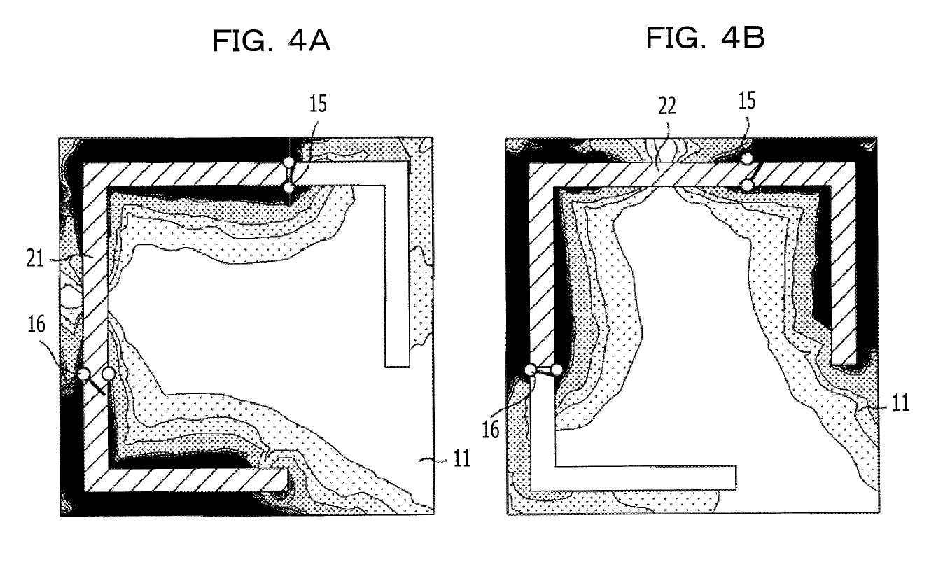

FIG. 4A and FIG. 4B illustrate an exemplary simulation result of current distribution. FIG. 4A illustrates a simulation result of distribution of a current flowing into the earth electrode 11 of the antenna device 1 when the two switches are provided so that the horizontally-polarized wave is emitted or received. FIG. 4B illustrates a simulation result of the distribution of the current flowing into the earth electrode 11 of the antenna device 1 when the two switches are provided so that the vertically-polarized wave is emitted or received. The simulation result may be obtained by electric field analysis using a finite element method.

In FIG. 4A and FIG. 4B, a dark-colored part indicates that the current is strong, and a light-colored part indicates that the current is weak. As illustrated in FIG. 4A and FIG. 4B, the current is strongest in both ends of the U-shaped sections 21 and 22 of the slot that is fed, and the current is weak in the vicinity of the center of the U-shaped section. In the vicinity of the center of the U-shaped section in which the current is weak, the switches 15 and 16 may be provided so that the switch to be turned off is positioned. Since the end of the section of the slot that is not fed is positioned in the vicinity of the section of the slot that is fed, the coupling of the section of the slot that is not fed and the section of the slot that is fed may be reduced. Therefore, the antenna device 1 may selectively emit or receive the linearly-polarized wave along one of the two polarization planes that mutually orthogonal.

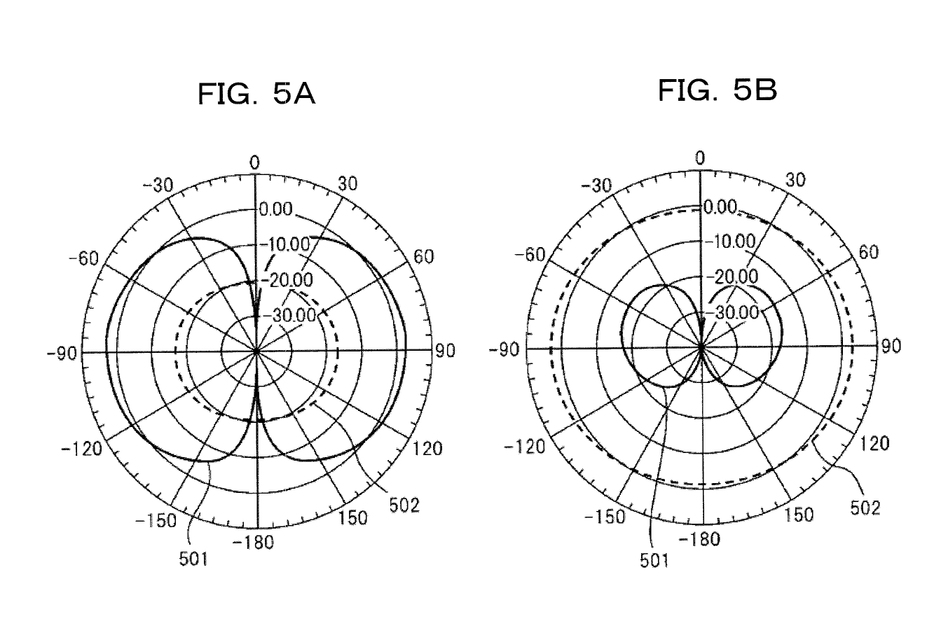

FIG. 5A and FIG. 5B illustrates an exemplary simulation result of a gain of the horizontally-polarized wave and the vertically-polarized wave and a directionality pattern. FIG. 5A illustrates a simulation result of the gain of the horizontally-polarized wave and the vertically-polarized wave and the directionality pattern on the surface that is parallel to the front surface of the substrate 10 of the antenna device 1 when two switches are provided so that the horizontally-polarized wave is emitted or received. FIG. 5B illustrates a simulation result of the gain of the horizontally-polarized wave and the vertically-polarized wave and the directionality pattern on the surface that is parallel to the front surface of the substrate 10 of the antenna device 1 when two switches are provided so that the vertically-polarized wave is emitted or received. Regarding the simulation, the radio frequency may be 1 GHz, the material of the earth electrode 11 may be copper, and the thickness of the earth electrode 11 may be 0.4 mm. The gain and the directionality pattern may be obtained by analyzing an electric field in a free space by the finite element method.

In FIG. 5A and FIG. 5B, a graph 501 indicates the directionality pattern of the gain of the horizontally-polarized wave, and a graph 502 indicates the directionality pattern of the gain of the vertically-polarized wave. The farther the point is separated from the center of the graph, the larger the gain (dBi unit) is. As illustrated in FIG. 5A, when the antenna device 1 is set to emit or receive the horizontally-polarized wave, the gain of the horizontally-polarized wave is larger than the gain of the vertically-polarized wave except in the vertical direction. As illustrated in FIG. 5B, when the antenna device 1 is set to emit or receive the vertically-polarized wave, the gain of the vertically-polarized wave is larger than the gain of the horizontally-polarized wave in all the directions. Therefore, the antenna device 1 may obtain a sufficient effect of the polarized wave diversity.

The length of the bent part 123 and the bent part 124 of the slot 12 may be long as much as possible. The longer the bent part is, the stronger the current flowing in the section that is fed in the slot 12 is. Thus, the distance between the feeding point and the switch positioned in the end of the section of non-feeding is longer. Therefore, the electric coupling of the section 21 and the section 22 of the slot 12 is reduced. The antenna device 1 may reduce the gain of the radio wave having the polarization plane that does not emit or receive the polarized wave.

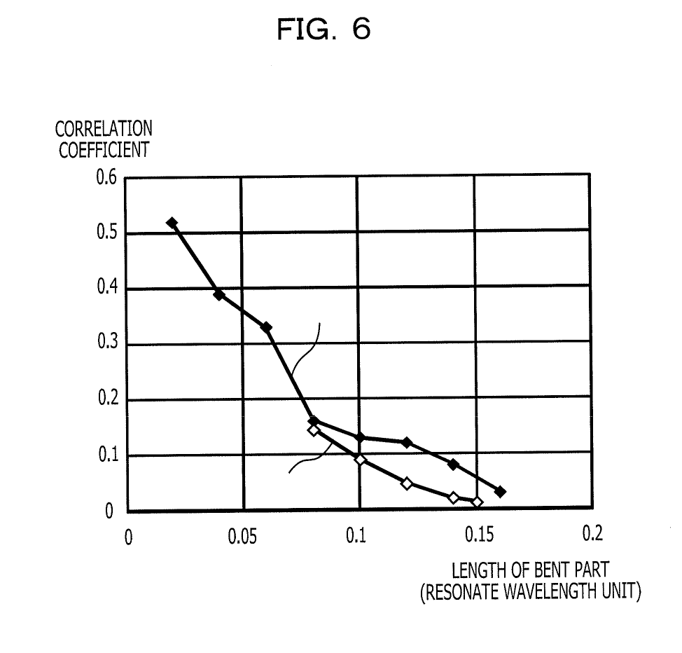

FIG. 6 illustrates an exemplary simulation result indicating a relationship between a length of a bent part and a correlation coefficient between polarized waves. Regarding the simulation, the electric field in the free space is analyzed by the finite element method. The earth electrode 11 may include copper, and the width W of the slot 12 may be 5.5 mm. The frequency of the radio wave that resonates with the slot antenna may be 1 GHz.

The horizontal axis indicates the length of the bent part 123 and the bent part 124. The longitudinal axis indicates the correlation coefficient between the horizontally-polarized wave and the vertically-polarized wave. A graph 600 indicates, for example, a relationship between the length of the bent part and the correlation coefficient where the length from the outside border of the width direction of the slot 12 to the end of the earth electrode 11 is 5 mm. A graph 601 indicates, for example, a relationship between the length of the bent part and the correlation coefficient where the length from the outside border of the width direction of the slot 12 to the end of the earth electrode 11 is 2.5 mm. In the graphs 600 and 601, the longer the bent part is, the lower the correlation coefficient is. The lower the correlation coefficient is, the lower the extent of the coupling of the slot antenna for the horizontally-polarized wave and the slot antenna for the vertically-polarized wave is. Thus, the effect of the polarized wave diversity may become high. For example, when the correlation coefficient is equal to or lower than 0.5, the sufficient effect of the polarized wave diversity may be obtained (see, for example, Fujimoto. “Antenna Kogengaku.” Quarterly journal SAWS 2000 Spring. 2000. Kikusui Electronics Corporation.). Regarding the antenna device, if the length of the bent part is equal to or longer than 0.03λ, the sufficient effect of the polarized wave diversity may be obtained.

If the length of the bent part 123 and the bent part 124 is equal to or longer than ⅙ of a resonant wavelength λ, the length from the switch 15 to the end point 12a on the lower side of the slot 12 is λ/2. Thus, the length of the part that is parallel to the vertical direction of the slot 12 may be λ/6. Therefore, the end point 12a on the lower side of the slot 12 may contact the end point 12c on the right side of the slot 12. The length of the bent part 123 and the bent part 124 may be set to less than λ/6.

The antenna device may function as a slot antenna that is able to selectively emit or receive the linearly-polarized wave along one of the two polarization planes that are mutually orthogonal. Regarding the antenna device, the switch is positioned so that the end of the slot antenna for the other linearly-polarized wave is positioned in the vicinity of the position where the current is weak when using the slot antenna for the linearly-polarized wave to be emitted or received. Therefore, regarding the antenna device, with respect to the gain for the radio wave having the linearly-polarized wave to be emitted or received, the gain for the linearly-polarized wave that is orthogonal to the linearly-polarized wave to be emitted or received may become sufficiently small. The antenna device may sufficiently obtain the effect of the polarized wave diversity.

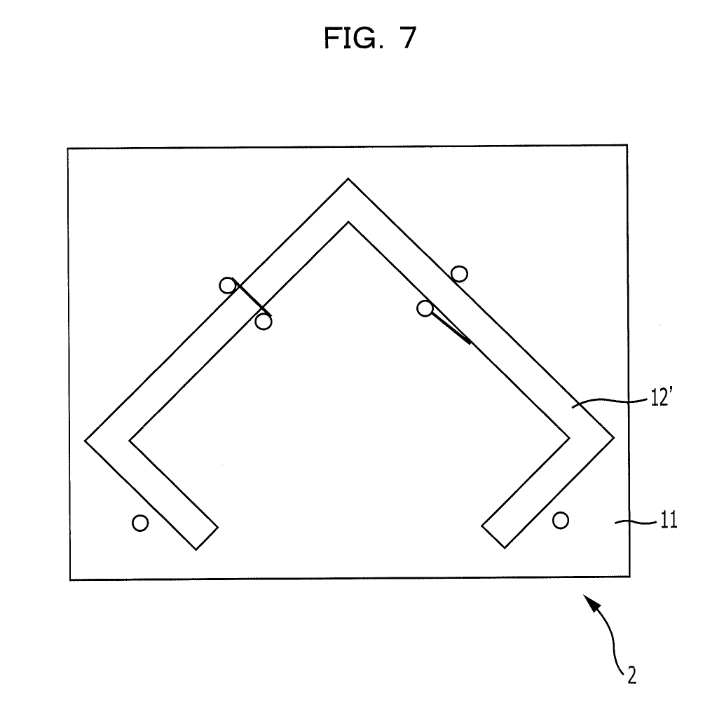

FIG. 7 illustrates an exemplary plain view of an antenna device. Compared to the antenna device 1 illustrated in FIG. 1, an antenna device 2 illustrated in FIG. 7 is formed in such a way that the sides of a slot 12′ formed in the earth electrode 11 have a slope with respect to the end sides of the earth electrode 11. Due to the slope of the slot 12′, the polarization plane on which the antenna device 2 emits or receives the radio wave may be oblique to the sides of the horizontal direction or the sides of the vertical direction of the earth electrode 11. The other structure and function of the antenna device 2 may be substantially the same as or similar to the structure and function of the antenna device 1 illustrated in FIG. 1.

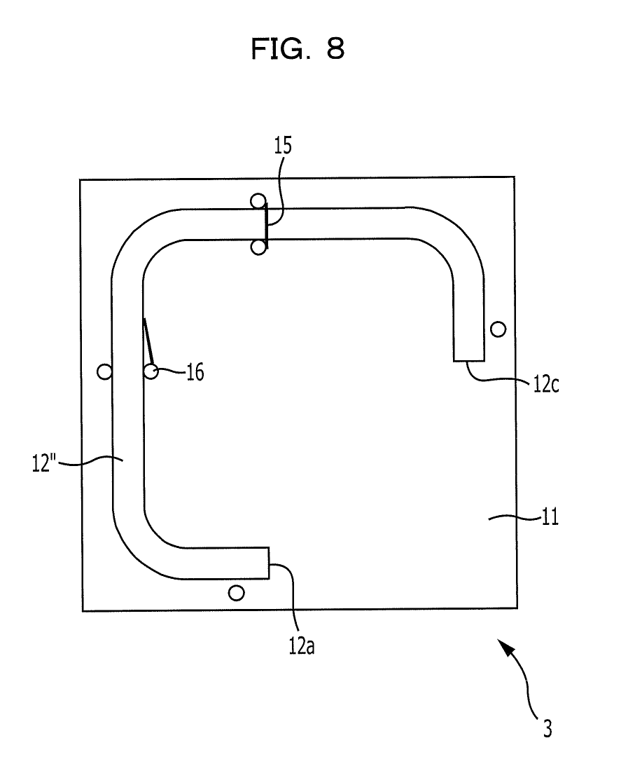

FIG. 8 illustrates an exemplary plain view of an antenna device. Compared to the antenna device 1 illustrated in FIG. 1, an antenna device 3 illustrated in FIG. 8 is formed in such a way that the corners of the slot 12′ formed in the earth electrode 11 are gradually curved. For example, when the slot may not be formed near the corner of the substrate as the antenna device is fixed, the antenna device 3 may provide the function that is substantially the same as the function of the antenna device 1 illustrated in FIG. 1. The width direction in the vicinity of the center of the section of the slot between the switch 15 and the end point 12a and the width direction in the vicinity of the center of the section of the slot between the switch 16 and the end point 12c may be mutually orthogonal in such a way that the two linearly-polarized waves to be emitted or received becomes orthogonal mutually. The other structure and function of the antenna device 3 may be substantially the same as or similar to the structure and function of the antenna device 1 illustrated in FIG. 1.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. An antenna device, comprising:
a substrate;
a slot, provided on the substrate, including an earth electrode, a first side, a second side, a first bent part and a second bent part, the first side and the second side being mutually orthogonal and one end of the first side coupled to one end of the second side, the first bent part being coupled to the other end of the second side and provided in parallel to the first side, the first bent part being shorter than the first side, the second bent part coupled to the other end of the first side and provided in parallel to the second side, the second bent part being shorter than the second side;
a first feeding point provided on the earth electrode in a vicinity of the first bent part;
a second feeding point provided on the earth electrode in the vicinity of the second bent part;
a first switch provided on the first side; and
a second switch provided on the second side.

2. The antenna device according to claim 1, wherein the first switch conducts a first earth electrode part and a second earth electrode part which are facing each other to sandwich the first side, and
wherein the second switch conducts a third earth electrode part and a fourth electrode part which are facing each other to sandwich the second side.

3. The antenna device according to claim 1, wherein the first side and the second side are shorter than a half of a wavelength of a radio wave which resonates.

4. The antenna device according to claim 1, wherein a length of a first section along the slot from an end point of the first bent part to the first switch and the length of a second section along the slot from an end point of the second bent part to the second switch are substantially a half of the wavelength of the radio wave which resonates.

5. The antenna device according to claim 1, wherein the radio wave having a first polarization plane is emitted or received by the first switch conducting the first earth electrode part and the second earth electrode part and by the second switch interrupting the third earth electrode part and the fourth earth electrode part.

6. The antenna device according to claim 4, wherein the first polarization plane goes along a width direction of the second side, and
wherein a first section along the slot from the end point of the first bent part to the first switch functions as a slot antenna which emits or receives the radio wave having the first polarization plane.

7. The antenna device according to claim 1, wherein the radio wave having a second polarization plane is emitted or received by the second switch conducting the third earth electrode part and the fourth earth electrode part and by the first switch interrupting the first earth electrode part and the second earth electrode part.

8. The antenna device according to claim 7, wherein the second polarization plane goes along the width direction of the first side, and
wherein a second section along the slot from the end point of the second bent part to the second switch functions as a slot antenna which emits or receives the radio wave having the second polarization plane.

9. The antenna device according to claim 1, wherein the first switch is provided in such a way that a length along the slot from the first switch to an intermediate point of the second side is equal to or longer than a length along the slot from the intermediate point to the first feeding point and is equal to or shorter than the length from the intermediate point to the end point of the first bent part.
